(19) United States
(12) Patent Application Publication
(10) Pub. No.: US 2026/0097640 A1
(43) Pub. Date: Apr. 9, 2026

(54) ANTICIPATIVE COOLING SYSTEM FOR BATTERY ELECTRIC VEHICLE

(71) Applicant: FCA US LLC, Auburn Hills, MI (US)

(72) Inventors: Alexander George, Auburn Hills, MI (US); Michael Wiland, Auburn Hills, MI (US)

(21) Appl. No.: 18/910,580

(22) Filed: Oct. 9, 2024

(51) Int. Cl. B60K 11/02; B60H 1/00; B60H 1/32; B60L 15/00; B60L 50/60

(52) U.S. Cl. CPC B60K 11/02; B60H 1/00278; B60H 1/00392; B60H 1/3208; B60H 1/323; B60L 15/007; B60L 50/60; B60H 2001/00307; B60H 2001/3272; B60H 2001/3277; B60L 2250/18

(57) ABSTRACT

A two-phase cooling system for an electrified vehicle includes a condenser, a first electronic drive module (EDM), a high voltage battery, a first vapor compression loop and a second vapor compression loop. The first EDM includes a first electric motor and a first power inverter module (PIM). The high voltage battery powers the first EDM. The first vapor compression loop provides cooling to the first EDM and includes a first liquid-vapor separator and a first pump that draws subcooled liquid from the condenser through the first liquid-vapor separator and directs the cooling liquid to the first EDM. A controller: receives driver inputs indicative of a thermal limit of the cooling system; determines, based on the driver inputs, that the thermal limit will be reached in a short future timeframe; and commands, based on the determination, the first compressor to increase compressor speed.

### FIELD

The present application generally to electrified vehicles and, more particularly, to a cooling system that provides cooling for a high voltage battery of the electrified vehicle using refrigerant.

### BACKGROUND

An electrified vehicle (hybrid electric, plug-in hybrid electric, range-extended electric, battery electric, etc.) includes at least one battery system and at least one electronic drive module (EDM) having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor provided on respective EDM's configured on the vehicle. In such electrified vehicles, it can become challenging to control temperatures of respective EDM's and the high voltage battery. One current solution for cooling an EDM is by using an ethylene glycol and water coolant to cool the dielectric oil inside the EDM by way of forced convention inside a dedicated heat exchanger. One current solution for cooling the high voltage battery is to draw heat from the cells using a thermal gel that transfers heat from the battery cells directly down to a cooling plate on the battery pack where heat is then removed by way of forced convection using ethylene glycol and water coolant. Such cooling systems can have low controllability. Additionally, electric vehicle propulsion systems offer high peak output, but for a short duration before they must either reduce power or overheat. In this regard, a cooling system has little to no effect on the available duration of maximum output. Instead, component temperature at the beginning of a power request does. Accordingly, while such cooling systems do work well for their intended purpose, there is a desire for improvement in the relevant art.

### SUMMARY

According to one example aspect of the invention, a two-phase cooling system for an electrified vehicle includes a condenser, a first electronic drive module (EDM), a high voltage battery, a first vapor compression loop and a second vapor compression loop. The first EDM includes a first electric motor and a first power inverter module (PIM). The high voltage battery powers the first EDM. The first vapor compression loop provides cooling to the first EDM and includes a first liquid-vapor separator and a first pump that draws subcooled liquid from the condenser through the first liquid-vapor separator and directs the cooling liquid to the first EDM. A controller: receives driver inputs indicative of a thermal limit of the cooling system; determines, based on the driver inputs, that the thermal limit will be reached in a short future timeframe; and commands, based on the determination, the first compressor to increase compressor speed.

In other examples, the controller: commands, based on the driver inputs, the first pump to increase pump speed.

In additional examples, the controller: commands, based on the driver inputs, a radiator fan to increase speed.

In other implementations, the controller: commands, based on the driver inputs, a lower subloop pressure to be reduced.

In other examples, the driver inputs include a driver selected driver mode.

In other features, the driver inputs include an adaptive feature that detects that the driver is engaged in aggressive driving.

In other implementations, the controller: commands, based on the maximum vehicle performance being requested, the first compressor to increase to a maximum compressor speed.

In still other examples, the controller: commands, based on the maximum vehicle performance being requested, the first pump to increase to a maximum first pump speed.

In additional examples, the controller: commands, based on the maximum vehicle performance being requested, the radiator fan to increase to a maximum radiator fan speed.

In other arrangements, the two-phase cooling system includes a second vapor compression loop that provides cooling to the battery and includes a second compressor that compresses fluid in the second vapor compression loop, a second liquid-vapor separator, and a second pump that draws subcooled liquid from the condenser through the second liquid-vapor separator and directs the cooling liquid to the battery.

In some implementations, the two-phase cooling system further includes a second EDM and a third vapor compression loop. The second EDM has a second electric motor and a second PIM. The third vapor compression loop provides cooling to the second EDM and includes a third liquid-vapor separator that separates liquid and vapor and a third pump that draws subcooled liquid from the condenser, through the third liquid-vapor separator and directs the cooling liquid to the second EDM.

In some implementations, a fourth vapor compression loop provides cooling to a cabin of the vehicle.

According to another example aspect of the invention, a method for controlling a two-phase cooling system for an electrified vehicle is provided. The method includes providing a condenser; a first electronic drive module (EDM) having a first electric motor, and a first power inverter module (PIM); a high voltage battery that powers the EDM; a first vapor compression loop that provides cooling to the first EDM, the first vapor compression loop comprising: a first compressor that compresses fluid in the first vapor compression loop; a first liquid-vapor separator that separates liquid and vapor; and a first pump that draws subcooled liquid from the condenser, through the first liquid-vapor separator and directs the cooling liquid to the first EDM; receiving driver inputs indicative of a thermal limit of the cooling system; determining, based on the driver inputs, that the thermal limit will be reached in a short future timeframe; and commanding, based on the determining, the first compressor to increase compressor speed.

In other features, the method includes commanding, based on the driver inputs, the first pump to increase pump speed.

In additional features, the method includes commanding, based on the driver inputs, a radiator fan to increase speed.

In additional examples, the method includes commanding, based on the driver inputs, a lower subloop pressure to be reduced.

In additional arrangements, the driver inputs include an adaptive feature that detects that the driver is engaged in aggressive driving.

In other examples, the driver inputs include a request for maximum vehicle performance.

In other features, the method includes commanding, based on the maximum vehicle performance being requested: the first compressor to increase to a maximum compressor speed; the first pump to increase to a maximum first pump speed; and the radiator fan to increase to a maximum radiator fan speed.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a two-phase cooling system for an electrified vehicle according to the principles of the present application;

FIGS. 2A and 2B is a logic flow diagram of a control system that controls the two-phase cooling system of FIG. 1 according to examples of the present application; and

FIG. 3 is an exemplary logic flow diagram of a control method for operating the two-phase cooling system of FIG. 1 according to examples of the present disclosure.

### DESCRIPTION

As discussed above, current solutions for cooling an EDM is to use ethylene/glycol/water coolant (hereinafter “antifreeze”) to cool the dielectric oil inside the EDM via forced convection inside a dedicated heat exchanger. A known solution for cooling the high voltage battery is to draw heat from the cells using a thermal gel that transfers heat from the battery cells directly down to a cooling plate at the bottom of the high voltage battery pack where the heat is then removed via forced convection using an antifreeze. To achieve the desired entering temperature for the coolant in the battery, a refrigerant-coolant heat exchanger, called a chiller, is used to remove some heat from the coolant before it enters the battery. All heat drawn from the individual components into the coolant, excepts what is removed by the chiller, is then rejected to ambient air via a radiator at the front of the vehicle. The extra heat removed from the coolant by the chiller is drawn into the refrigeration circuit shared by the cabin and is rejected to the ambient air via a condenser at the front of the vehicle. The coolant is circulated throughout the system using one or more pumps and the refrigerant is circulated using a standard air conditioning compressor.

An antifreeze cooling solution provides low controllability of the EDM temperature due to high thermal capacitance of a coolant based cooling system. For heat to be transferred in a forced convection system, the heat from the EDM must first increase the temperature of the oil, which then will increase the temperature of the aluminum in the heat exchanger, which then will transfer heat to the coolant. This is a slow reacting system because as the temperatures of the oil and heat exchanger surfaces are increasing, so too is the EDM component temperature. This can lead to local overheating of the EDM oil and a degradation of the performance of the EDM. One known method for cooling high voltage batteries has low controllability of the battery cells due to the same high thermal capacitance of the coolant but also the high thermal capacitance of the thermal gel and low heat transfer coefficients for forced convection over a plate. It also can decrease the gravimetric/volumetric battery energy density because the cooling plate is heavy and does not contribute to the total amount of energy that the battery can store for its given weight and volume.

The cooling system according to the present disclosure provides a control system that anticipates that the thermal limit of the main components of the electrified vehicle may soon be reached. Before high power has been requested, the pressure in the saturated segments of the cooling system are lowered, reducing the refrigerant temperature, increasing the temperature delta, increasing the heat rate, and, in time, reducing the temperature of the cooled components. This will increase the duration for which maximum power can be applied to the vehicle drive wheels.

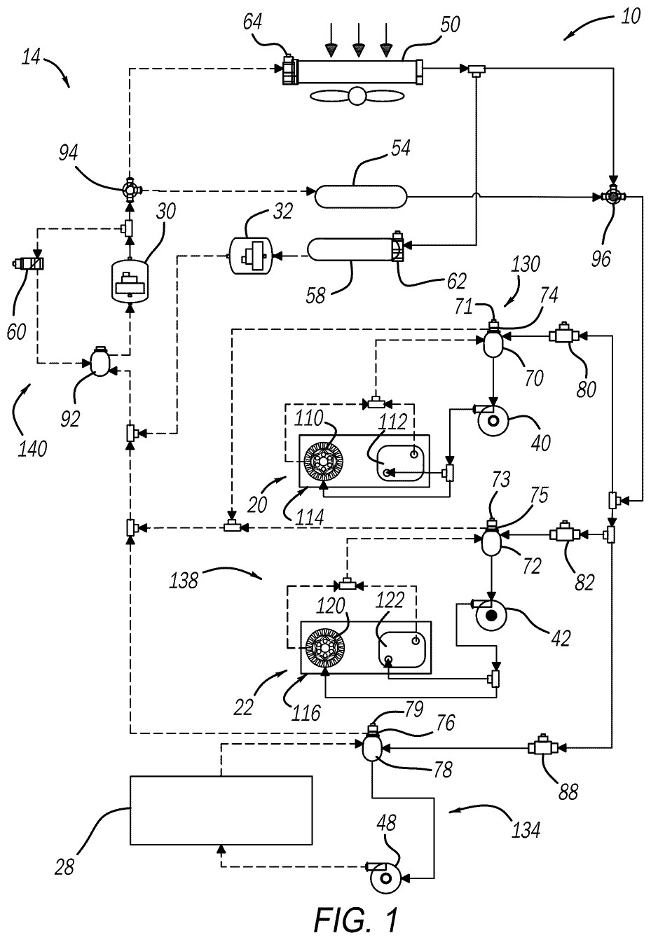

Referring now to FIG. 1, a functional block diagram of an example two phase cooling system is shown and generally identified at reference numeral 10. The two phase cooling system can be incorporated into an electrified vehicle 14 (also referred to herein as “vehicle 14”) according to the principles of the present application. In general, the fluid represented in FIG. 1 is shown as a solid line to denote a liquid and a dashed line to denote a vapor. The two phase cooling system 10 generally includes a first EDM 20, a second EDM 22, a high voltage battery 28, a first compressor 30, a second compressor 32, a first refrigerant pump 40 associated with the first EDM 20, a second refrigerant pump 42 associated with the second EDM 22, a third refrigerant pump 48 associated with the high voltage battery 28, a radiator 50, a condenser 54, an evaporator 58, and a first, second and third expansion device 60, 62 and 64. The two phase cooling system 10 can further include a first, second and third liquid-vapor separators 70, 72 and 78 having respective pressure regulator valves 71, 73 and 79. Sensors 74, 75 and 76 associated with the liquid-vapor separators 70, 72 and 78 and first EDM 20 measure liquid level, pressure and temperature in the first liquid-vapor separator 70. The first liquid-vapor separator 70 is fluidly connected to a first mass flow metering device 80. The second liquid-vapor separator 72 is fluidly connected to a second mass flow metering device 82. The third liquid-vapor separator 78 is fluidly connected to a third mass flow metering device 88. A fourth liquid-vapor separator 92 fluidly connected to the first compressor 30. A first and second proportional switching valve 94 and 96 are fluidly connected to the condenser 54 and the radiator 50, respectively.

The vehicle 14 includes an electrified powertrain having the EDM's 20 and 22 configured to generate and transfer drive torque to a driveline for vehicle propulsion. In the example shown the first EDM 20 is configured to power the front driveline of the vehicle 14 while the second EDM 22 is configured to power the second driveline of the vehicle 14. It is appreciated that while the example shown includes two EDM's, the present cooling system can be used for electrified powertrains that include one or more than two EDM's. The first EDM 20 generally includes a first electric drive motor 110 (e.g., electric traction motor), and power electronics including a first power inverter module (PIM) 112. A first water jacket 114 is provided internal to the first EDM 20 for communicating liquid through the first EDM 20. Similarly, the second EDM 22 generally includes a second electric drive motor 120, and power electronics including a second PIM 122. A second water jacket 116 is provided internal to the second EDM 22 for communicating liquid through the second EDM 22. While the example shown herein includes water jackets 114 and 116, heat may be transferred from the EDM's 20 and 22 to the refrigerant in other ways. For example, instead of water jackets that route refrigerant though the respective EDM's, the EDM's could simply use a plate style heat exchanger to transfer heat between a lubricating oil, which is internal to the EDM, and the refrigerant. This plate heat exchanger, commonly known as a chiller, could eliminate the need for the water jacket in the EDM. The PIM's 112 and 122 converts the current supplied by the high voltage battery 28 from DC to AC which the motors 110, 120 can then use to provide motive force for the vehicle 14.

The two phase cooling system 10 generally provides a first vapor compression loop 130, a second vapor compression loop 134, a third vapor compression loop 138 and a fourth vapor compression loop 140. The first, second, third and fourth vapor compression loops 130, 134, 138 and 140 provide cooling for the first and second EDM's 20, 22, the high voltage battery 28 and the cabin of the vehicle 14. Specifically, the first vapor compression loop 130 provides cooling to the first EDM 20. The second vapor compression loop 134 provides cooling to the high voltage battery 28. The third vapor compression loop 138 provides cooling to the second EDM 22. The fourth vapor compression loop 140 provides cooling to the vehicle cabin.

Operation of the first vapor compression loop 130 will be described. The pump 40 draws subcooled liquid from the condenser 54 through the metering device 80 and directs the liquid to the first water jacket 114. The heat from the first EDM 20 and the first PIM 112 partially evaporates some of the refrigerant flowing through the first water jacket 114. The process results in a two-phase mixture leaving the first water jacket 114 which is then sent to the liquid-vapor separator 70. The liquid in the liquid-vapor separator 70 has a much higher density and will therefore settle in the bottom of the liquid-vapor separator 70 via gravity. The pump 40 will then continue to draw the liquid from the bottom of the liquid-vapor separator 70 and circulate it back into the first EDM 20. The vapor from the liquid-vapor separator 70 is drawn off by the AC compressor 30 through the pressure regulation valve 71. This vapor is then sent to the condenser 54 where it will be cooled. This now subcooled liquid will then re-enter the first vapor compression loop 130 via suction of the pump 40.

The amount of liquid that is allowed back into the first vapor compression loop 130 is dictated by an amount of vapor that has left. In an unmetered loop, by conservation of mass, the total mass of liquid to re-enter the first vapor compression loop 130 will be equal to the amount of vapor mass that has been pulled off into the first vapor compression loop 130. However, this may lead to a system that will constantly be full of liquid and therefore cannot benefit from as much boiling heat transfer. The metering device 80 slows down the amount of liquid refrigerant flowing back into the first vapor compression loop 130 by restricting the line. The overall pressure, and therefore temperature, in the first vapor compression loop 130 is then regulated by the pressure regulator 71 and the metering device 80 based on measurements communicated by the sensor 74.

Operation of the third vapor compression loop 138 will be described. The pump 42 draws subcooled liquid from the condenser 54 through the metering device 82 and directs the liquid to the second water jacket 116. The heat from the second EDM 22 and the second PIM 122 partially evaporates some of the refrigerant flowing through the second water jacket 116. The process results in a two-phase mixture leaving the second water jacket 116 which is then sent to the liquid-vapor separator 72. The liquid in the liquid-vapor separator 72 has a much higher density and will therefore settle in the bottom of the liquid-vapor separator 72 via gravity. The pump 42 will then continue to draw the liquid from the bottom of the liquid-vapor separator 72 and circulate it back into the second EDM 22. The vapor from the liquid-vapor separator 72 is drawn off by the AC compressor 30 through the pressure regulation valve 73. This vapor is then sent to the condenser 54 where it will be cooled. This now subcooled liquid will then re-enter the third vapor compression loop 138 via suction of the pump 42.

The amount of liquid that is allowed back into the third vapor compression loop 138 is dictated by an amount of vapor that has left. In an unmetered loop, by conservation of mass, the total mass of liquid to re-enter the third vapor compression loop 138 will be equal to the amount of vapor mass that has been pulled off into the third vapor compression loop 138. However, this may lead to a system that will constantly be full of liquid and therefore cannot benefit from as much boiling heat transfer. The metering device 82 slows down the amount of liquid refrigerant flowing back into the third vapor compression loop 138 by restricting the line. The overall pressure, and therefore temperature, in the third vapor compression loop 138 is then regulated by the pressure regulator 73 and the metering device 82 based on measurements communicated by the sensor 75.

Operation of the second vapor compression loop 134 will be described. The pump 48 draws subcooled liquid from the condenser 54 through the metering device 88 and directs the liquid to the battery 28. It is appreciated that the battery includes a manifold and associated cooling plates for circulating the liquid. The heat from the high voltage battery 28 partially evaporates some of the refrigerant flowing through the battery cooling manifold. The process results in a two-phase mixture leaving the high voltage battery 28 which is then sent to the liquid-vapor separator 78. The liquid in the liquid-vapor separator 78 has a much higher density and will therefore settle in the bottom of the liquid-vapor separator 78 via gravity. The pump 48 will then continue to draw the liquid from the bottom of the liquid-vapor separator 78 and circulate it back into the high voltage battery 28. The vapor from the liquid-vapor separator 78 is drawn off by the AC compressor 30 through the pressure regulation valve 79. This vapor is then sent to the condenser 54 where it will be cooled. This now subcooled liquid will then re-enter the second vapor compression loop 134 via suction of the pump 48. Notably, the pressure of the refrigerant at the inlet of the pump 48 is controlled to a much lower value so that the temperature in the second vapor compression loop 134 will be low enough to allow for proper heat transfer away from the high voltage battery 28.

The amount of liquid that is allowed back into the second vapor compression loop 134 is dictated by an amount of vapor that has left. In an unmetered loop, by conservation of mass, the total mass of liquid to re-enter the second vapor compression loop 134 will be equal to the amount of vapor mass that has been pulled off into the second vapor compression loop 134. However, this may lead to a system that will constantly be full of liquid and therefore cannot benefit from as much boiling heat transfer. The metering device 88 slows down the amount of liquid refrigerant flowing back into the second vapor compression loop 134 by restricting the line. The overall pressure, and therefore temperature, in the second vapor compression loop 134 is then regulated by the pressure regulator 79 and the metering device 88 based on measurements communicated by the sensor 76.

According to features of the present disclosure, pressure at the outlet of the liquid-vapor separators 70, 72 and 78 is controlled to match the suction pressure required for the evaporator 58 to operate properly. This is key to the functionality of the cooling system 10 as it ensures proper directional flow of the refrigerant to the compressor 32 so that the vapor can be compressed and then condensed at the front of the vehicle 14.

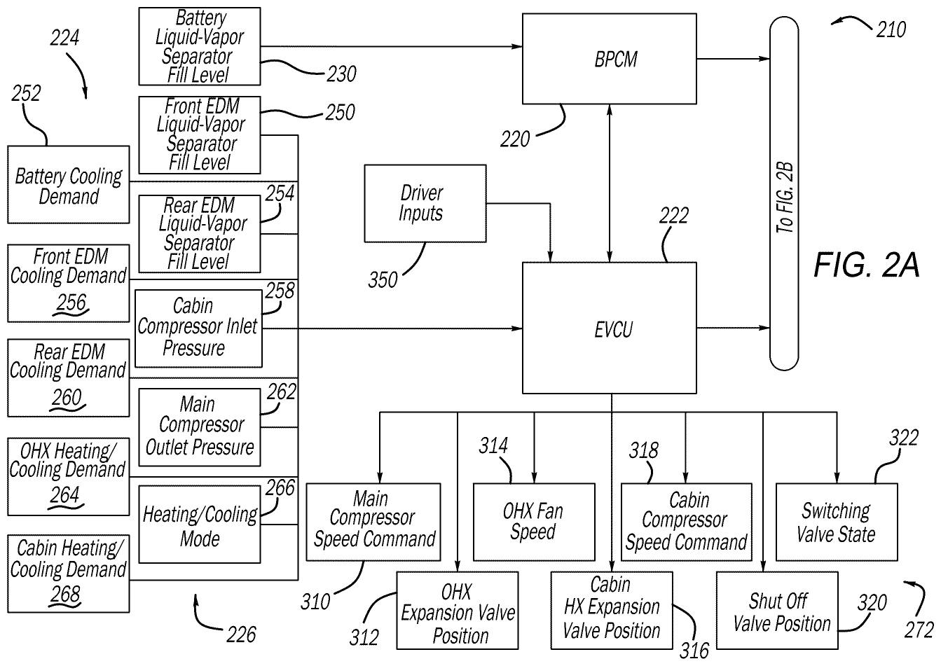

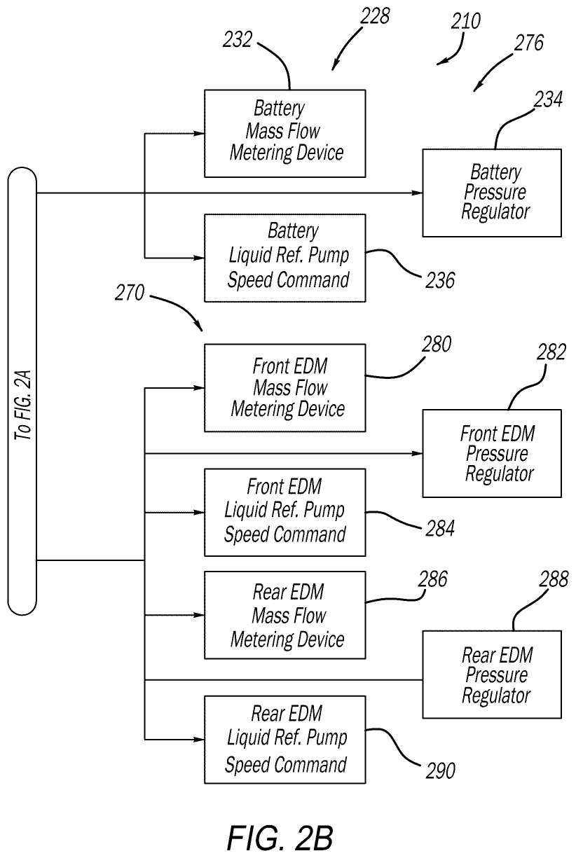

With continued reference to FIG. 1 and additional reference to FIGS. 2A and 2B, a control system 210 that controls the two-phase cooling system 10 will be described. The control system 210 generally includes a battery pack control module (BPCM) 220 and an electric vehicle control module or unit (EVCU) 222. While the control system 210 is represented with two distinct controllers, the control system 210 may be configured for use with a single controller or more than two controllers. As such, the following discussion will generally refer to “control”. Vehicle outputs 224 represent calculations based on vehicle activity such as, but not limited to, throttle input, charging state, discharge rate. The vehicle outputs 224 are received by the EVCU 222 and include a cooling demand 252 for the battery 28, a cooling demand 256 for the first EDM 20, a cooling demand 260 for the second EDM 22, a heating/cooling demand 264 for the radiator 50 and a heating/cooling demand 268 for the vehicle cabin. Sensor outputs 226 represent measured values for various sensors in the system 10. The sensor outputs 226 are received by the EVCU 222 and include a fill level 250 for the liquid-vapor separator 70, a fill level 254 for the liquid-vapor separator 72, an inlet pressure 258 for the cabin compressor 32, and a heating/cooling mode input 266. A fill level 230 of the liquid-vapor separator 78 is input to the BPCM 220.

A first group of actuators 228 are adjusted based on signals received by the BPCM 220 based on the vehicle outputs 224 and the sensor outputs 226. The first group of actuators 228 include an actuator 232 for the mass flow metering device 88 for the battery 28, and an actuator 236 that commands a speed of the pump 48.

A second group of actuators 270 are adjusted based on signals received by the EVCU 222 based on the vehicle outputs 224 and the sensor outputs 226. The second group of actuators 270 include an actuator 280 for the mass flow metering device 80 for the first EDM 20, an actuator 284 that commands a speed of the pump 40, an actuator 286 for the mass flow metering device 82 for the second EDM 22, an actuator 290 that commands a speed of the pump 42.

A third group of actuators 272 are adjusted based on signals received by the EVCU 222 based on the vehicle outputs 224 and the sensor outputs 226. The third group of actuators 272 include an actuator 310 that commands a speed of the compressor 30, an actuator 312 that controls a position of the expansion valve 64, an actuator 314 that controls the speed of the fan on the radiator 50, an actuator 316 that controls a position of the expansion valve 62, an actuator 318 that commands a speed of the compressor 32, an actuator 320 that controls a position of a shut off valve in the compressor 32 and an actuator 322 that the state of the switching valves 94, 96. If cabin demand is such that the evaporator 58 does not need refrigerant flow, then the cabin compressor is off and flow through the compressor should be stopped.

A group of regulators 276 are passive devices of the system 10 and regulate the pressure inside the respective loops by allowing vapor to escape once a pressure differential is overcome. The regulators 272 include a first pressure regulator 234 for the battery 28, a second pressure regulator 282 for the first EDM 20 and a third pressure regulator 288 for the second EDM 22.

The control system 210 can further receive driver inputs 350, such as at the EVCU 222. Driver inputs 350 can include any driver selected drive mode, such as, but not limited to sport, performance, track, etc. Driver inputs 350 can further include indication that launch control has been activated, the vehicle 14 has been driven to a track, an adaptive feature that detects that the driver is engaged in aggressive driving, a model of the driver's behavior that predicts aggressive driving, etc. The pressure in the saturated segments of the cooling system 10 is lowered thereby reducing the refrigerant temperature, increasing the temperature delta, increasing the heat rate and, in time, reducing the temperature of the cooled components. This will increase the duration for which maximum power can be applied to the vehicle drive wheels. The cooling system 10 and control system 210 allows for motors and inverters to be downsized which reduces cost, and allows for an increased duration of peak performance.

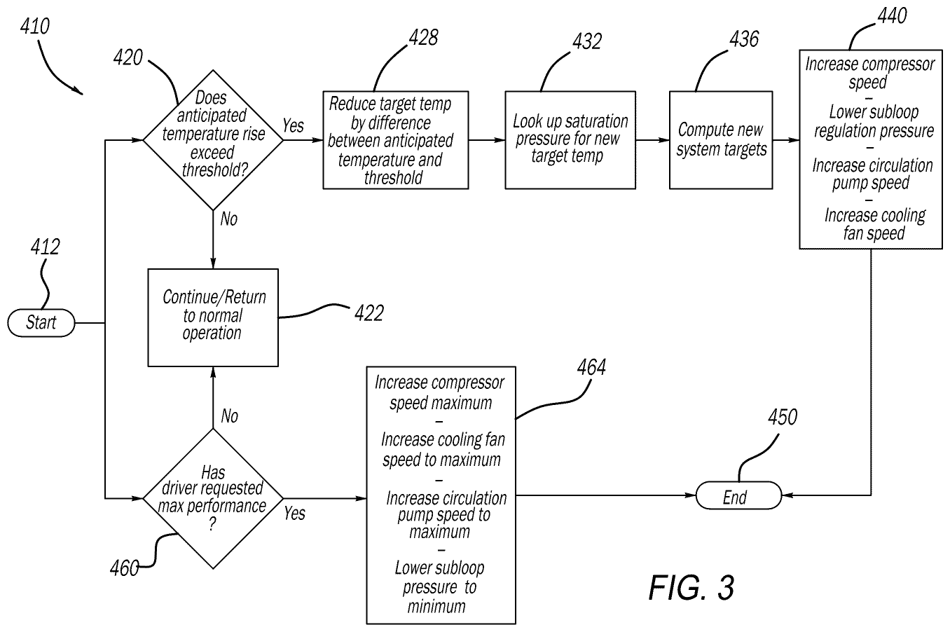

With particular reference to FIG. 3, an exemplary method for controlling the system 10 is shown and generally identified at reference numeral 410. The method starts at 412. At 420, control determines whether an anticipated temperature rise will exceed a threshold. The anticipated temperature rise can be estimated based on a driver inputs 350 described above. If control determines that the anticipated temperature rise does not exceed the threshold, control continues with normal operation at 422. If control determines that the anticipated temperature rise will exceed the threshold, control reduces a target temperature by a difference between the anticipated temperature and the threshold at 428. At 432, control looks up a saturation pressure based on the target temperature. The saturation pressure can be determined by any suitable method such as, but not limited to, a lookup table. At 436, control computes new system targets based on the saturation pressure. At 440, control commands system components to implement the new system targets. In examples, control commands at least one of the compressors 30 and 32 to increase speed. Control can further command a lower subloop regulation pressure. Control can further command at least one of the pumps 40, 42 and 48 to increase circulation speed. Control can further command the fan on the radiator 50 to increase speed. Control ends at 450.

At 460, control determines if the driver has requested maximum performance. Again, control can determine if this request has been satisfied based on the driver inputs 350. If control determines that maximum performance has not been requested, control continues with normal operation at 422. If control determines that the driver has requested maximum performance, control commands system components to implement maximum system targets. In examples, control commands at least one of the compressors 30 and 32 to maximum speed. Control can further command a lower subloop regulation pressure to a minimum pressure. Control can further command at least one of the pumps 40, 42 and 48 to increase circulation speed to a maximum speed. Control can further command the fan on the radiator 50 to increase speed to a maximum speed. Control ends at 450.

In addition to the advantages outlined above, the system 10 provides additional advantages over conventional cooling arrangements. For example, boiling of a refrigerant occurs at a single temperature which is controlled by the pressure in the refrigeration loop. This allows for tighter control of the EDM component temperature, the PIM component temperature, and the high voltage battery cell temperature and simplifies the controls of the system by allowing for longer reaction times to turning up pump flow or releasing pressure from the accumulators. A flooded evaporator type system in self-regulating in the fact that if there is a step change in the heat generated by any component then the temperature of the component does not change, only the refrigerant vapor generation rate changes. This is simple to react to using a level sensor inside of the accumulators.

In other advantages, the system 10 is a simplification of the front cooling module for the vehicle. With all the heat generated by the individual loops being transferred to refrigerant vapor and the collection of all individual loop's vapor mass into a single vapor-compression cycle, the front cooling module of the vehicle can be reduced to a single heat exchanger, which reduces air-side restriction, which, in turn, reduces the overall fan power required to cool the vehicle.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A two-phase cooling system for an electrified vehicle, the two-phase cooling system comprising:
a condenser;
a first electronic drive module (EDM) having a first electric motor, and a first power inverter module (PIM);
a high voltage battery that powers the first EDM;
a first vapor compression loop that provides cooling to the first EDM, the first vapor compression loop comprising:
a first compressor that compresses fluid in the first vapor compression loop;
a first liquid-vapor separator that separates liquid and vapor; and
a first pump that draws subcooled liquid from the condenser, through the first liquid-vapor separator and directs the cooling liquid to the first EDM; and
a controller that:
receives driver inputs indicative of a thermal limit of the cooling system;
determines, based on the driver inputs, that the thermal limit will be reached in a short future timeframe; and
commands, based on the determination, the first compressor to increase compressor speed.

2. The two-phase cooling system of claim 1, wherein the controller:
commands, based on the driver inputs, the first pump to increase pump speed.

3. The two-phase cooling system of claim 1, wherein the controller:
commands, based on the driver inputs, a radiator fan to increase speed.

4. The two-phase cooling system of claim 1, wherein the controller:
commands, based on the driver inputs, a lower subloop pressure to be reduced.

5. The two-phase cooling system of claim 1, wherein the driver inputs include a driver selected driver mode.

6. The two-phase cooling system of claim 1, wherein the driver inputs include an adaptive feature that detects that the driver is engaged in aggressive driving.

7. The two-phase cooling system of claim 1, wherein the driver inputs include a request for maximum vehicle performance.

8. The two-phase cooling system of claim 7, wherein the controller:
commands, based on the maximum vehicle performance being requested, the first compressor to increase to a maximum compressor speed.

9. The two-phase cooling system of claim 7, wherein the controller:
commands, based on the maximum vehicle performance being requested, the first pump to increase to a maximum first pump speed.

10. The two-phase cooling system of claim 7, wherein the controller:
commands, based on the maximum vehicle performance being requested, the radiator fan to increase to a maximum radiator fan speed.

11. The two-phase cooling system of claim 1, further comprising:
a second vapor compression loop that provides cooling to the high voltage battery, the second vapor compression loop comprising:
a second compressor that compresses fluid in the second vapor compression loop;
a second liquid-vapor separator that separates liquid and vapor; and
a second pump that draws subcooled liquid from the condenser through the second liquid-vapor separator and directs the cooled liquid to the battery.

12. The two-phase cooling system of claim 11, further comprising:
a second EDM having a second electric motor and a second PIM; and
a third vapor compression loop that provides cooling to the second EDM, the third vapor compression loop comprising:
a third liquid-vapor separator that separates liquid and vapor; and
a third pump that draws subcooled liquid from the condenser, through the third liquid-vapor separator and directs the cooling liquid to the second EDM.

13. The two-phase cooling system of claim 12, further comprising:
a fourth vapor compression loop that provides cooling to a cabin of the vehicle.

14. A method for controlling a two-phase cooling system for an electrified vehicle, the method comprising:
providing a condenser; a first electronic drive module (EDM) having a first electric motor, and a first power inverter module (PIM); a high voltage battery that powers the EDM; a first vapor compression loop that provides cooling to the first EDM, the first vapor compression loop comprising: a first compressor that compresses fluid in the first vapor compression loop; a first liquid-vapor separator that separates liquid and vapor; and a first pump that draws subcooled liquid from the condenser, through the first liquid-vapor separator and directs the cooling liquid to the first EDM;
receiving driver inputs indicative of a thermal limit of the cooling system;
determining, based on the driver inputs, that the thermal limit will be reached in a short future timeframe; and
commanding, based on the determining, the first compressor to increase compressor speed.

15. The method of claim 14, further comprising:
commanding, based on the driver inputs, the first pump to increase pump speed.

16. The method of claim 14, further comprising:
commanding, based on the driver inputs, a radiator fan to increase speed.

17. The method of claim 14, further comprising:
commanding, based on the driver inputs, a lower subloop pressure to be reduced.

18. The method of claim 14, wherein the driver inputs include an adaptive feature that detects that the driver is engaged in aggressive driving.

19. The method of claim 14, wherein the driver inputs include a request for maximum vehicle performance.

20. The method of claim 14, further comprising:
commanding, based on the maximum vehicle performance being requested:
the first compressor to increase to a maximum compressor speed;
the first pump to increase to a maximum first pump speed; and
the radiator fan to increase to a maximum radiator fan speed.
